(19) United States
(12) Patent Application Publication
(10) Pub. No.: US 2017/0364382 A1
(43) Pub. Date: Dec. 21, 2017

(54) METHOD AND APPARATUS FOR HOT UPGRADING A VIRTUAL MACHINE MANAGEMENT SERVICE MODULE

(71) Applicant: ALIBABA GROUP HOLDING LIMITED, George Town (KY)

(72) Inventor: Yibo ZHOU, Hangzhou (CN)

(73) Assignee: ALIBABA GROUP HOLDING LIMITED

(21) Appl. No.: 15/625,981

(22) Filed: Jun. 16, 2017

(30) Foreign Application Priority Data
Jun. 17, 2016 (CN) 201610435481.8

(51) Int. Cl. G06F 9/455

(52) U.S. Cl. CPC G06F 9/45558; G06F 2009/45591

(57) ABSTRACT

Embodiments of the disclosure provide a method and an apparatus for hot upgrading a virtual machine management service module. The method includes creating a request receiving thread and a request handling thread by a virtual machine management service module process, wherein the request receiving thread receives a service request during the hot upgrading; creating a handling thread management unit; and managing, by the handling thread management unit, exit and new start of the request handling thread during the hot upgrading.

### CROSS REFERENCE TO RELATED APPLICATION

The disclosure is based on and claims the benefits of priority to Chinese Application No. 201610435481.8, filed Jun. 17, 2016, the entire contents of which are incorporated herein by reference.

### TECHNICAL FIELD

The disclosure relates to a field of computers, and in particular to a technology for hot upgrading a virtual machine management service module.

### BACKGROUND

A virtualization platform has become a mainstream of technical development in the field of Internet because of its better performance as well as flexible and convenient service capability. Xen is an open source code virtualization platform, providing services that allow multiple computer operating systems to execute on the same computer hardware concurrently, and Xend is the Xen Daemon or Xend Daemon for managing all virtual machines. Therefore, Xend is a virtual machine management service module. In Xen, as an important module in the life cycle of a virtual machine (VM), Xend determines whether operations of the VM such as creation, shutdown and destruction can be implemented smoothly. Meanwhile, it is an indispensable link in the whole control system.

The Xend runs on a physical server in a manner of a daemon process (a background process), and mainly includes two services: an HTTP Server (a hypertext transfer protocol service) and a XMLRPC Server (a standard generalized markup language-based remote process call protocol service). The two services are used to process operation requests sent by libvirt (a virtualization tool interface library) and an xm command (a basic management tool of Xen, including start, restart and shutdown), respectively.

From the perspective of a server, the conventional hot upgrade method is that each server starts two processes, and the two processes exit alternately for upgrade. Such a manner is implemented only when the two processes of the server are independent of each other, and have no data interaction. However, for the Xend, the processes started in the Xend may register some recall events for a VM, meanwhile including some timed tasks. If the same event is registered for multiple times, data inconsistence may be caused. By taking a VM Release event as an example, if the same VM is released for multiple times, an Xend may be Cored (broken down).

As the scale of a cloud cluster is ever increasing and the iteration speed of the version of the whole control system is accelerated, the incapability of hot upgrade can be considered problematic. During each version iteration of the Xend, it may appropriate to stop selling and limit related operations of users to prevent VM operations from failing. This not only affects user experiences, but also causes greater burden to operation and maintenance.

### SUMMARY

An objective of the disclosure is to provide a method and an apparatus capable of implementing hot upgrade of a virtual machine management service module, to solve the problem in the prior art that a virtual machine management service module cannot be hot upgraded.

Embodiments of the disclosure provide a method for hot upgrading a virtual machine management service module, comprising: creating a request receiving thread and a request handling thread by a virtual machine management service module process, wherein the request receiving thread receives a service request during the hot upgrading; creating a handling thread management unit; and managing, by the handling thread management unit, exit and new start of the request handling thread during the hot upgrading.

Embodiments of the disclosure further provide an apparatus for hot upgrading a virtual machine management service module, comprising: a thread creation device, configured to create a request receiving thread and a request handling thread by a virtual machine management service module process, wherein the request receiving thread continuously receives a service request during the hot upgrading; a management creation device, configured to create a handling thread management unit; and the handling thread management unit, configured to manage, by the handling thread management unit, exit and new start of the request handling thread during the hot upgrading.

### BRIEF DESCRIPTION OF THE DRAWINGS

The drawings herein are provided, as a part of the disclosure, for further understanding of the disclosure. Illustrative embodiments of the disclosure and description thereof are used to explain the disclosure, and are not restrictive. In the drawings,

FIG. 1 illustrates an exemplary flow chart for hot upgrading a virtual machine management service module, according to some embodiments of the disclosure;

FIG. 2 illustrates an exemplary schematic module structural diagram of a virtual machine management service module, according to some embodiments of the disclosure;

FIG. 3 illustrates an exemplary schematic diagram of a data flow of a virtual machine management service module, according to some embodiments of the disclosure;

FIG. 4 illustrates an exemplary flow chart of exit and new start of the request handling thread during management of hot upgrade by the handling thread management unit, according to some embodiments of the disclosure;

FIG. 5 illustrates an exemplary schematic flow chart of hot upgrade for a virtual machine management service module, according to some embodiments of the disclosure;

FIG. 6 illustrates an exemplary flow chart for hot upgrading a virtual machine management service module, according to some embodiments of the disclosure;

FIG. 7 illustrates an exemplary apparatus for hot upgrading a virtual machine management service module, according to some embodiments of the disclosure;

FIG. 8 illustrates an exemplary handling thread management device, according to some embodiments of the disclosure; and

FIG. 9 illustrates an exemplary apparatus for hot upgrading a virtual machine management service module, according to some embodiments of the disclosure.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The objects, features, and characteristics of the disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended as a definition of the limits of the invention. As used in the specification and in the claims, the singular form of “a”, “an”, and “the” include plural referents unless the context clearly dictates otherwise.

Embodiments of the disclosure will be further described below in detail with reference to the accompanying drawings.

To hot upgrade a virtual machine management service module, it may need to ensure the following aspects during the upgrade: 1. a service request from the external, such as libvirt (libvirt is an open source tool for managing platform virtualization), cannot be lost; 2. a request from the internal (such as internal shutdown and restart) cannot be lost; and 3. an upper layer control system is unaware of the upgrade.

Some embodiments of the disclosure separate receiving and handling of a request by improving two server processes to create a request receiving thread and a request handling thread in the server processes. The request receiving thread and the request handling thread may interact with each other through a queue (e.g., a message stack) of the threads. Meanwhile, a handling thread management unit is introduced. When the handling thread management unit is initialized, it initiates the two request handling threads. During a hot upgrade, the handling thread management unit may send an exit signal to the request handling thread, and the request handling thread may exit to a service request management device again after receiving the exit signal. The service request management device may determine, according to an exit type (e.g., an exit reason), whether it is a normal shutdown type or a hot upgrade type. If it is the hot upgrade type, the handling thread management unit may enable an earlier request handling thread to exit, and then start a new request handling thread.

Further, a call type of a main logic processing module related to the virtual machine management service module is set as a service request handling thread call type. The main logic processing module is changed from being called globally to being called in the handling thread. Therefore, when a new handling thread is activated, the main logic processing module is updated accordingly, thereby implementing the hot upgrade.

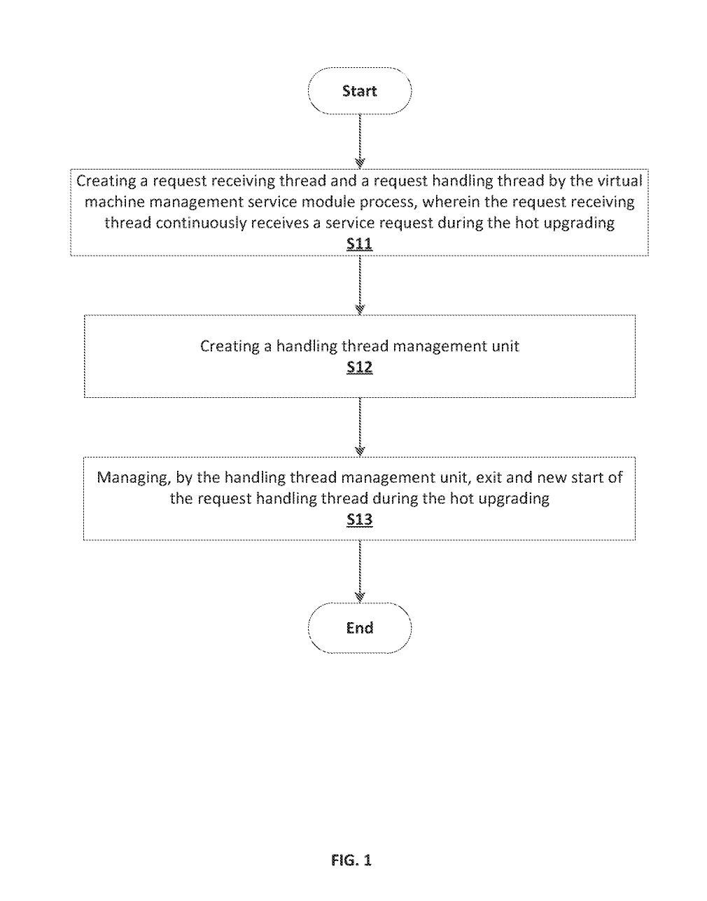

Accordingly, FIG. 1 illustrates an exemplary method for hot upgrading a virtual machine management service module according to some embodiments of the disclosure. The method may include steps S11-S13 as below.

In step S11, a request receiving thread and a request handling thread are created by a virtual machine management service module process. The request receiving thread continuously receives service requests during a hot upgrade. For example, the request receiving thread can continuously receive a service request within expected intervals or without interruption.

In step S12, a handling thread management unit is created.

In step S13, the handling thread management unit manages exit and new start of the request handling thread during the hot upgrade.

Generally, the virtual machine management service module runs on a physical server as a background process (a Daemon process), and may include multiple server processes according to operation requests sent by different command tools. The multiple server processes may include a hypertext transfer protocol server process (HTTP Server process) and a standard generalized markup language-based remote process call protocol server handling process (XMLRPC Server process).

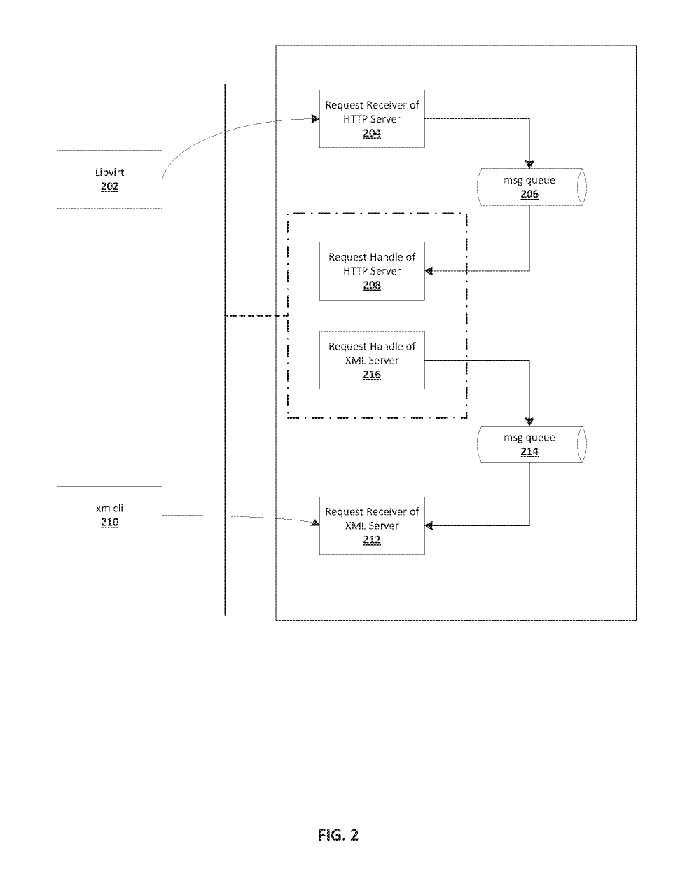

FIG. 2 illustrates an exemplary schematic module structural diagram of a virtual machine management service module according to embodiments of the disclosure. In some embodiments, Xend will be taken as an example. Each Xend daemon e.g., a virtual machine management service module process) mainly has three work processes, including an HTTP server request handling process, an XMLRPC Server request handling process, and a handling thread management unit process. A request receiving thread and a request handling thread of each server process interact with each other based on a message queue of the threads.

During normal work, a control system calls a libvirt (a virtualization tool interface library) interface 202 to send a service request to an HTTP server of the Xend. A service request receiving thread 204 (e.g., a request receiver of the HTTP server) receives the service request, and sends the service request to a message stack 206 (e.g., an msg queue). And a service request handling thread 208 (e.g., request handle of the HTTP server) conducts operations, such as shutdown, creation, and releasing, for a virtual machine (VM). Meanwhile, a command line tool 210 (e.g., xm cli) included in the Xend may send a service request through the XMLRPC Server, a service request receiving thread 212 (e.g., a request receiver of the Extensible Markup Language (XML) server) receives the service request, and sends the service request to a message stack 214 (e.g., the msg queue), and a service request handling thread 216 (e.g., a request handle of the XML server) conducts related operations of the virtual machine. Moreover, a handling thread control device (e.g., a Server Manager) manages the hot upgrade of the Xend by controlling the upgrade of the service request handling thread.

Further, in step S11 of FIG. 1, the virtual machine management service module process creates the request receiving thread and the request handling thread. The request receiving thread is configured to continuously receive the service request, conduct parsing and encoding, and send the encoded service request to a message stack, and the request handling thread extracts the encoded service request from the message stack and handles the service request.

In some embodiments, by separating the receiving of the service request from the handling of the service request to generate two interfaces, the receiving and handling of the service request are both changed into multi-thread processing. The service request receiving thread parses the received service request, encodes the service request into an object that is recognizable by the message stack, and puts the object into a message queue of the message stack. The service request handling thread extracts, from the message queue of the message stack, the object corresponding to the service request, and decodes the object for processing.

The request receiving thread continuously receives the service request, and parses the received service request to determine whether it is a normal request. If the service request is not a normal request, the request receiving thread feeds back an error or an error message, and if the service request is a normal request, the request receiving thread encodes the service request. The request receiving thread may further send the encoded service request to the message stack. The request handling thread continuously extracts the encoded service request from the message stack, decodes the encoded service request, parses the decoded service request, and queries whether there is a processing method corresponding to the service request. If the processing method exists, the request handling thread handles the service request, and if the method does not exist, the request handling thread raises an error.

In the process of handling the service request by the virtual machine management service module, the main logic processing module that processes the service request is called by the request handling thread. The request handling thread may be restarted during the upgrade process. During the hot upgrade, the request receiving thread can continuously receive a service request, correspondingly parse and encode the service request, and send the encoded service request to the message stack. After the request handling thread finishes the hot upgrade, a new request handling thread acquires, from the message stack, the encoded service request and processes it, such that an external service request will not be lost and the control layer is unaware.

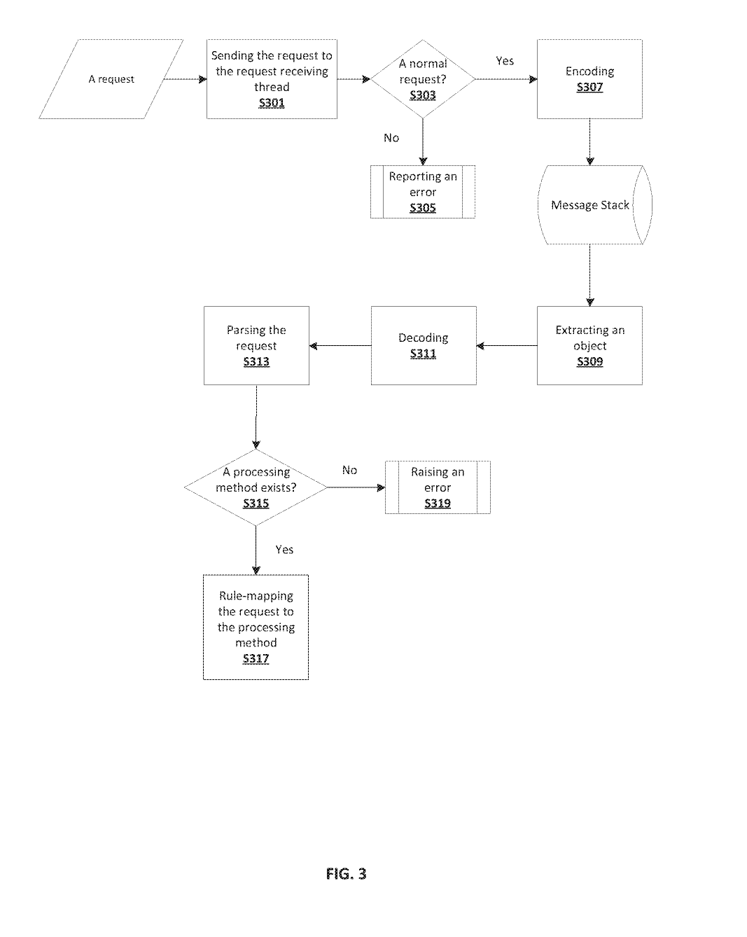

FIG. 3 illustrates an exemplary schematic diagram of a data flow of a virtual machine management service module according to some embodiments of the disclosure. An Xend work flow will be taken as an example of the data flow, and the Xend work flow may include the following.

1. A control system sends a service request through libvirt or xm cli (a command line tool) at S301.

2. The service request receiving thread may determine whether the service request is a normal request at S303, and report an error to a request initiator if the service request is not a normal request at S305; and if the service request is a normal request, encode the service request and then put it in the message stack (msg queue) to wait for processing by the request handling thread at S307.

3. The service request handling thread may extract a corresponding request object from the message stack (msg queue) at S309, and decode the request object at S311.

4. The service request handling thread may parse the decoded service request at S313, determine whether a processing method corresponding to the service request exists at S315, rule-map the service request to the specific processing method for processing at S317 if the processing method exists, and raising an error to the request initiator if there is no corresponding method at S319.

Further, as described above, in step S12, a handling thread management unit is created.

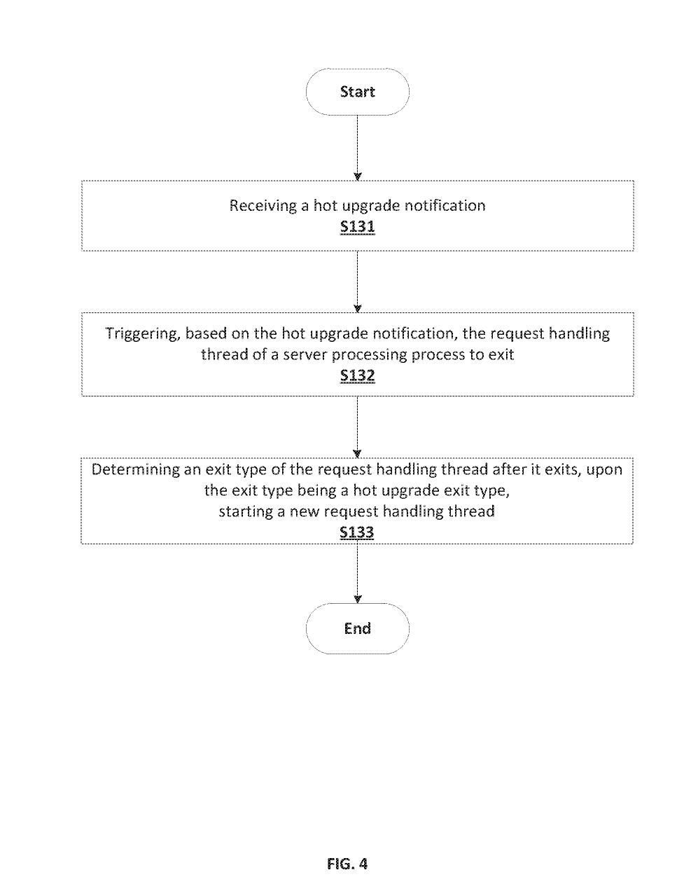

FIG. 4 illustrates an exemplary flow chart of exit and new start of the request handling thread during management of hot upgrade by the handling thread management unit according to some embodiments of the disclosure. As shown in FIG. 4, step S13 of FIG. 1 can include step S131, step S132 and step S133.

In step S131, a hot upgrade notification is received.

In step S132, based on the hot upgrade notification, the request handling thread of a service processing process is triggered to exit. Further, in step S132, the handling thread management unit can wait for the request handling thread to check whether the service request is being handled currently. And if the service request is being handled currently, the request handling thread can wait to exit until the handling is completed.

In step S133, an exit type of the request handling thread is determined after it exits, and if it is a hot upgrade exit type, a new request handling thread is started. Moreover, in step S133, the handling thread management unit can determine the exit type of the request handling thread after it exits. If the exit type is a hot upgrade exit type, the handling thread management unit starts a new request handling thread further by extracting the parsed service request from the message stack by the new request handling thread after a new request handling thread is started.

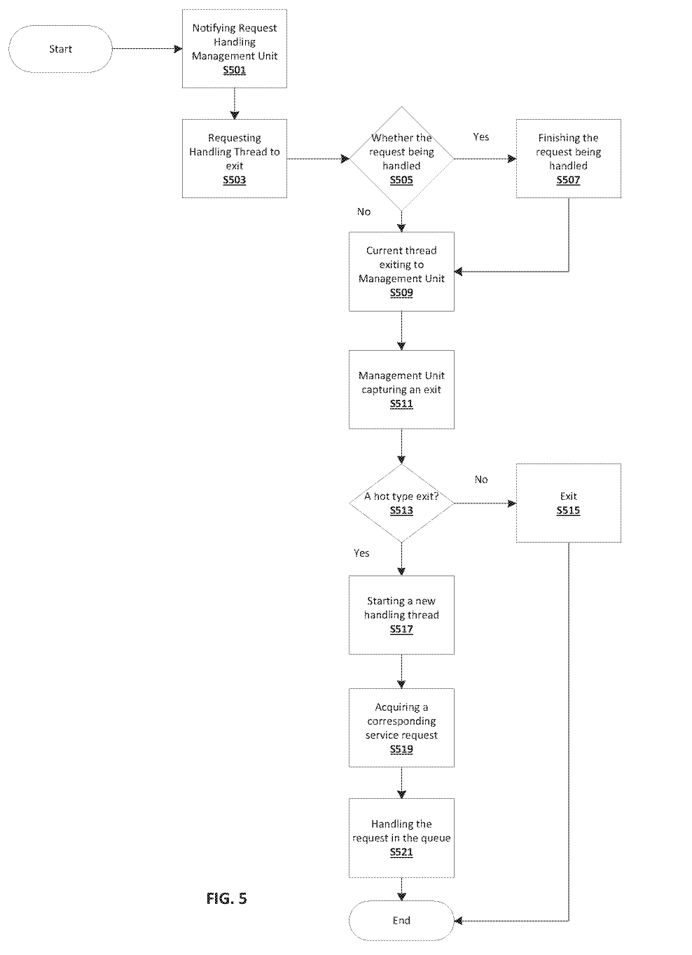

FIG. 5 illustrates an exemplary schematic flow chart of hot upgrade for a virtual machine management service module according to some embodiments of the disclosure. The hot upgrade method for the Xend in the disclosure includes the following.

1. A hot upgrade (e.g., Xend reload) interface notifies at S501, by sending a hot upgrade signal, the request handling thread management unit to perform the hot upgrade.

2. The handling thread management unit triggers, after receiving the hot upgrade signal, to request the service request handling thread to exit at S503.

3. The service request handling thread may check whether the request is being handled currently at S505. And if the request is being handled currently, the service request handling thread may exit after the handling of the request being handled currently is completed at S507.

4. The service request handling thread exits to the handling thread management unit at S509. And the handling thread management unit determines, according to the exit type, for example, acquired at S511 by an exit signal id (e.g., Exit Signal ID), whether it is a hot upgrade or a normal exit (shutdown) at S513. If it is a normal exit, the service request handling thread exits directly at S515, and if it is a hot upgrade, after the service request handling thread exits, a new service request handling thread is started at S517.

5. The new service request handling thread may actively acquire, from the message stack, a corresponding service request for processing at S519.

During the hot upgrade, the message stack continuously receives the service request parsed and sent by the service request receiving thread. And after the hot upgrade ends, the new service request handling thread may handle service requests backlogged in the queue during the hot upgrade at S521, and then continue to handle normal service requests, thereby ensuring that no message is lost during the hot upgrade and the control system is unaware.

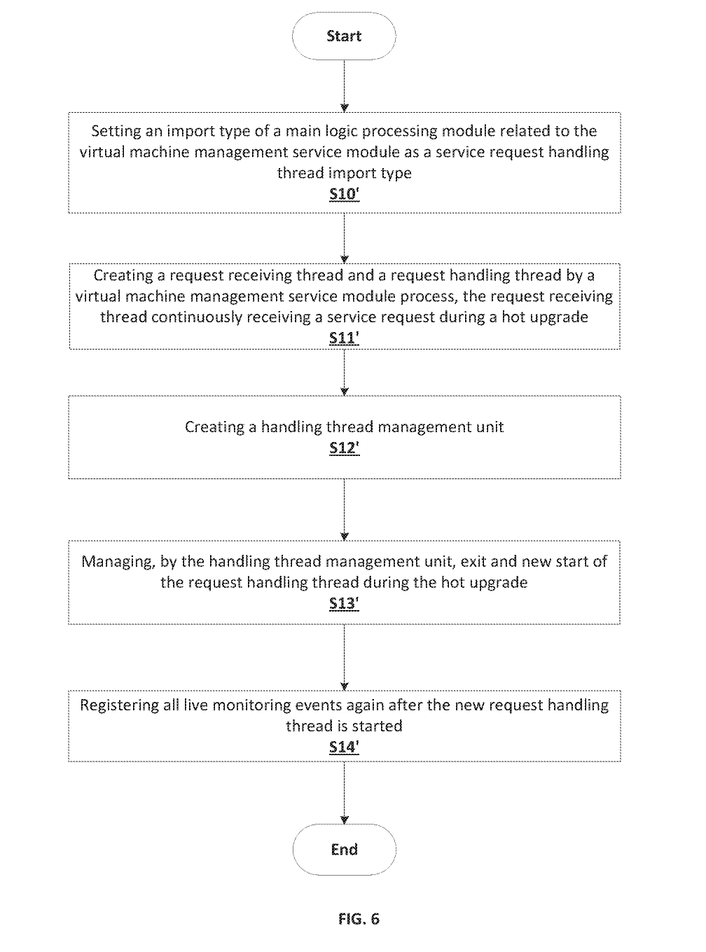

FIG. 6 illustrates an exemplary method for hot upgrading a virtual machine management service module provided according to some embodiments of the disclosure. The method includes step S10′, step S11′, step S12′, step S13′ and step S14′.

Steps S11′, S12′ and S13′ are identical or basically identical to steps S11, S12 and S13 as shown in FIG. 1, description of which is not repeated herein for simplicity.

In some embodiments, the method further includes step S10′. In step S10′, an import type of a main logic processing module related to the virtual machine management service module is set as a service request handling thread import type. By changing from being imported globally to being imported merely in the service request handling thread (e.g., being imported in a request processing function) for two main logic processing modules to be upgraded, it can be ensured that the modified main logic processing modules are reloaded after the hot upgrade is completed.

Further, the method further includes step S14′. In step S14′, all live monitoring events are re-registered after the new request handling thread is started, to monitor events of the new request handling thread.

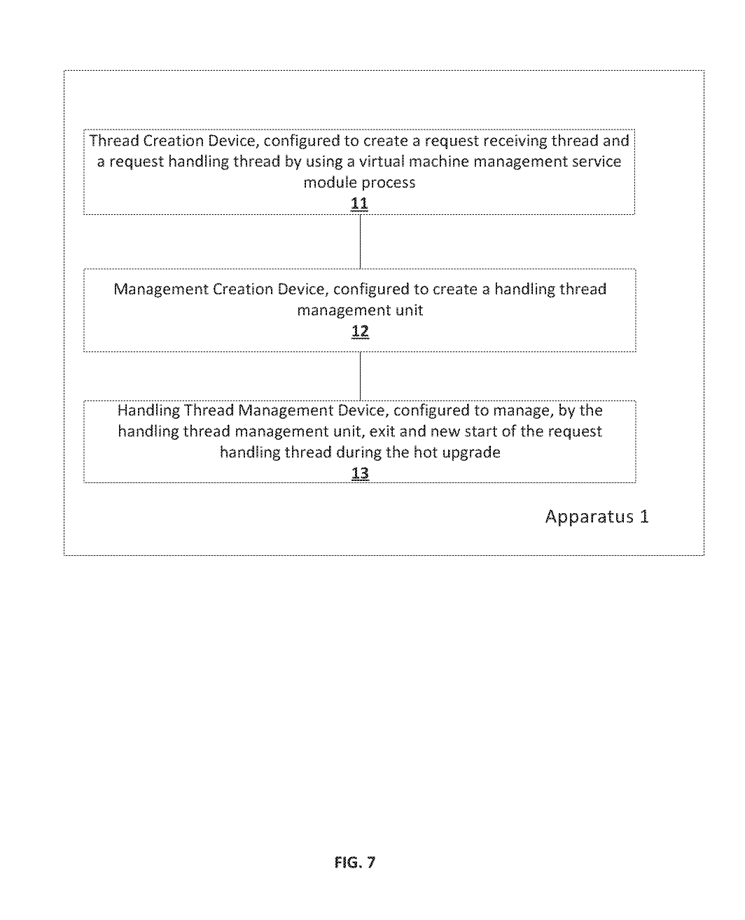

According to some embodiments of the disclosure, FIG. 7 illustrates an exemplary apparatus for hot upgrading a virtual machine management service module. The apparatus includes: a thread creation device 11, a management creation device 12, and a handling thread management device 13. These devices (and any units or sub-units of the devices) can be packaged functional hardware devices designed for use with other components (e.g., portions of an integrated circuit) or a parts of a program (stored on a computer readable medium) that performs a particular function of related functions.

Thread creation device 11 creates a request receiving thread and a request handling thread by using a virtual machine management service module process. The request receiving thread continuously receives a service request during the hot upgrade. Management creation device 12 creates a handling thread management unit. Handling thread management device 13 manages, by the handling thread management unit, exit and new start of the request handling thread during the hot upgrade.

Generally, the virtual machine management service module runs on a physical server as a background process (e.g., a Daemon process), and may include multiple server processes according to processing on operation requests sent by different command tools, such as a Hypertext Transfer Protocol server process (HTTP Server process) and a standard generalized markup language-based remote process call protocol server process (XMLRPC Server process).

As shown in FIG. 2, by taking Xend as an example, each Xend daemon (virtual machine management service module process) mainly has three work processes, including an HTTP server request handling process, an XMLRPC server request handling process, and a handling thread management unit process. A request receiving thread and a request handling thread of each server process interact with each other based on a message queue of the threads.

During normal work, a control system calls a libvirt (virtualization tool interface library) interface to send a service request to an HTTP server of the Xend. The service request receiving thread (request receiver of the HTTP server) receives the service request, sends the service request to the message stack (msg queue), and a service request handling thread (request handle of the HTTP server) conducts operations of the VM such as shutdown, creation, and releasing. Meanwhile, a command line tool (xm cli) of the Xend may send a service request through the XMLRPC server. A service request receiving thread (request receiver of XML server) receives the service request, and sends the service request to a message stack (msg queue), and a service request handling thread (request handle of XML server) conducts related operations of the virtual machine. Moreover, a handling thread control device (Server Manager) manages to implement hot upgrade work of the Xend by controlling the upgrade of the service request handling thread.

Further, thread creation device 11 creates the request receiving thread and the request handling thread by a virtual machine management service module process. The request receiving thread is configured to continuously receive the service request, conduct parsing and encoding, and send the encoded service request to a message stack. The request handling thread extracts the encoded service request from the message stack and handles the service request.

In some embodiments, by separating the receiving of the service request from the handling of the request to generate two interfaces, the receiving and handling of the service request are both changed into multi-thread processing. The service request receiving thread parses the received service request, encodes the service request into an object recognizable by the message stack, and puts the object into a message queue of the message stack. The service request handling thread extracts the object corresponding to the service request from the message queue of the message stack, and decodes the object for processing.

The request receiving thread continuously receives the service request, parses the received service request to determine whether it is a normal request. If the service request is not a normal request, the request receiving thread feeds back an error or an error message, and if the service request is a normal request, the request receiving thread encodes the service request. The request receiving thread may further send the encoded service request to the message stack. The request handling thread continuously extracts the encoded service request from the message stack, decodes the encoded service request, parses the decoded service request, and queries whether there is a method corresponding to the service request. If the method exists, the request handling thread handles the service request, and if the method does not exist, the request handling thread raises an error.

In the process of handling the service request by the virtual machine management service module, the main logic processing module that processes the service request is called by the request handling thread. The request handling thread may be restarted during the upgrade process. During the hot upgrade, the request receiving thread can continuously receive a service request, correspondingly parse and encode the service request, and send the encoded service request to the message stack. After the request handling thread finishes the hot upgrade, a new request handling thread acquires, from the message stack, the encoded service request and processes it, such that an external service request will not be lost and the control layer is unaware.

As shown above in FIG. 7, apparatus 1 can hot upgrade a virtual machine management service module, of which an exemplary data flow was described above in FIG. 3. As described previously, FIG. 3 illustrates an exemplary schematic diagram of a data flow of a virtual machine management service module according to some embodiments of the disclosure. An Xend work flow will be taken as an example of the data flow, and the Xend work flow may include the following.

1. A control system sends a service request through libvirt or xm cli (a command line tool) at S301.

2. The service request receiving thread may determine whether the service request is a normal request at S303, and report an error to a request initiator if the service request is not a normal request at S305; and if the service request is a normal request, encode the service request and then put it in the message stack (msg queue) to wait for processing by the request handling thread at 5307.

3. The service request handling thread may extract a corresponding request object from the message stack (msg queue) at S309, and decode the request object at S311.

4. The service request handling thread may parse the decoded service request at S313, determine whether a processing method corresponding to the service request exists at S315, rule-map the service request to the specific processing method for processing if the processing method exists at S317, and raising an error to the request initiator if there is no corresponding method at S319.

In some embodiments, management creation device 12 creates the handling thread management unit. Handling thread management device 13 manages, by the handling thread management unit, exit and new start of the request handling thread during the hot upgrade.

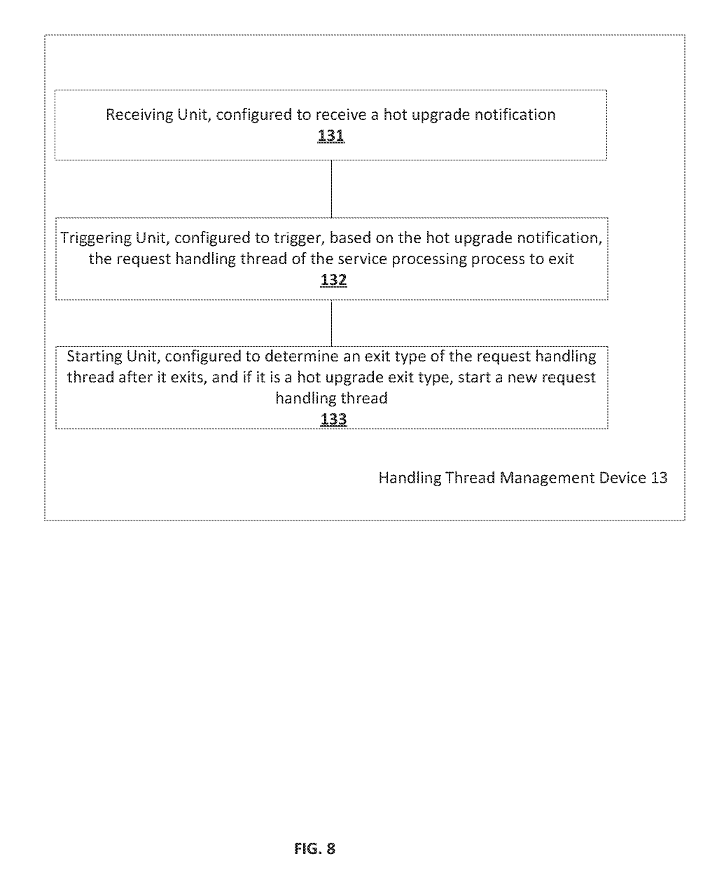

FIG. 8 illustrates an exemplary schematic diagram of the handling thread management device according to some embodiments of the disclosure. Further, the handling thread management device 13 includes: a receiving unit 131, configured to receive a hot upgrade notification; a triggering unit 132, configured to trigger, based on the hot upgrade notification, the request handling thread of the service processing process to exit; and a starting unit 133, configured to determine an exit type of the request handling thread after it exits, and if it is a hot upgrade exit type, start a new request handling thread.

Further, triggering unit 132 is further configured to wait for the request handling thread to check whether the service request is being handled currently, and if the service request is being handled currently, triggering unit 132 waits to exit until the processing is completed. Moreover, starting unit 133 is further configured to determine an exit type of the request handling thread after it exits. And if the exit type is a hot upgrade exit type, starting unit 133 starts a new request handling thread further by: after a new request handling thread is started, extracting the parsed service request from the message stack by the new request handling thread.

As shown above in FIG. 8, the handling thread management device 13 can manage exit and new start of the request handling thread during the hot upgrade, of which an exemplary flow chart was described above in FIG. 4. As described previously, FIG. 4 illustrates an exemplary flow chart of exit and new start of the request handling thread during management of hot upgrade by the handling thread management unit according to some embodiments of the disclosure. As shown in FIG. 4, managing, by the handling thread management unit, exit and new start of the request handling thread during the hot upgrade can include step S131, step S132 and step S133.

In step S131, a hot upgrade notification is received.

In step S132, based on the hot upgrade notification, the request handling thread of a service processing process is triggered to exit. Further, in step S132, the handling thread management unit can wait for the request handling thread to check whether the service request is being handled currently. And if the service request is being handled currently, the request handling thread can wait to exit until the handling is completed.

In step S133, an exit type of the request handling thread is determined after it exits, and if it is a hot upgrade exit type, a new request handling thread is started. Moreover, in step S133, the handling thread management unit can determine the exit type of the request handling thread after it exits. If the exit type is a hot upgrade exit type, the handling thread management unit starts a new request handling thread further by extracting the parsed service request from the message stack by the new request handling thread after a new request handling thread is started.

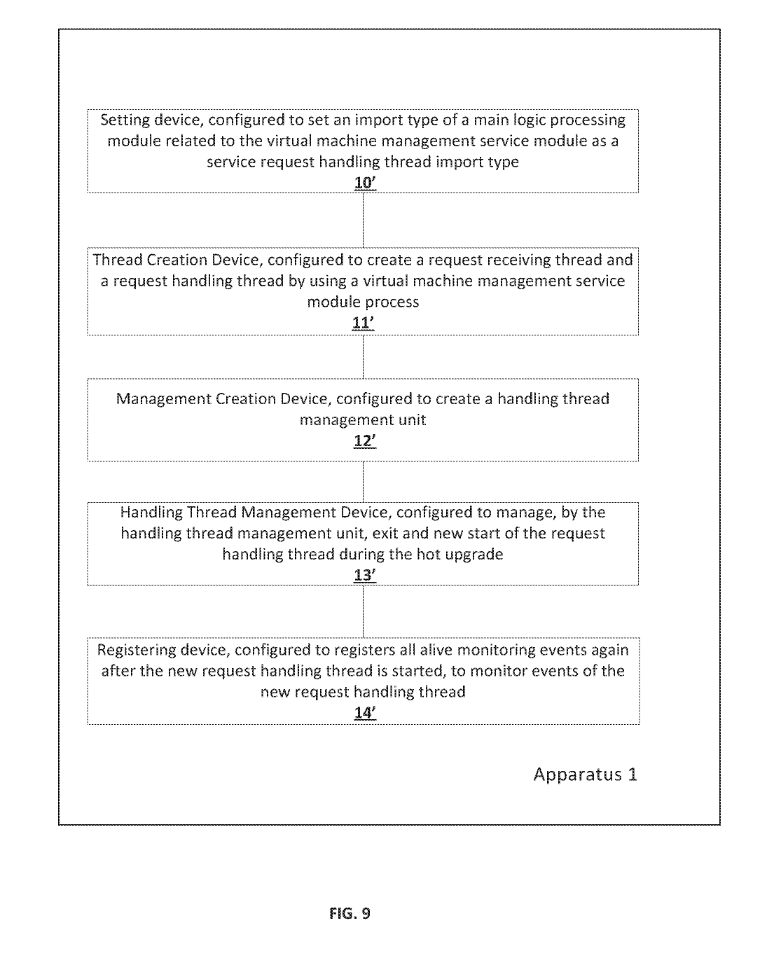

FIG. 9 illustrates an exemplary apparatus for hot upgrading a virtual machine management service module, according to some embodiments of the disclosure. The apparatus may include a setting device 10′, a thread creation device 11′, a management creation device 12′, a handling thread management device 13′, and a registering device 14′. These devices (and any units or sub-units of the devices) can be packaged functional hardware devices designed for use with other components (e.g., portions of an integrated circuit) or a parts of a program (stored on a computer readable medium) that performs a particular function of related functions.

Thread creation device 11′, management creation device 12′, and handling thread management device 13′ are identical or basically identical to thread creation device 11, management creation device 12, and handling thread management device 13, description of which is omitted herein for simplicity.

In some embodiments, the apparatus further includes setting device 10′. Setting device 10′ may set an import type of a main logic processing module related to the virtual machine management service module as a service request handling thread import type. By changing from being imported globally to being imported merely in the service request handling thread (e.g., being imported in a request processing function) for two main logic processing modules to be upgraded, it can be ensured that the modified main logic processing modules are reloaded after the hot upgrade is completed.

Further, the apparatus further includes registering device 14′. Registering device 14′ re-registers all live monitoring events after the new request handling thread is started, to monitor events of the new request handling thread.

The method and apparatus for hot upgrading a virtual machine management service module provided by embodiments of the disclosure improves service request handling processes. A service request receiving thread is separated from a service request handling thread, the receiving and handling of the service request are both changed into multi-thread processing, a main processing logic for the service request is changed from being called globally to being called in the handling thread. During the hot upgrade of the virtual machine management service module, the service request receiving thread continuously receives a service request, and sends the service request after being parsed and encoded to a message stack. After the service request handling thread exits and starts a new service request receiving thread, the main processing logic is then reloaded and finishes the upgrade.

Further, the service request handling thread may be managed by the handling thread. When a hot upgrade signal is received, the service request handling thread will be notified to exit, and an exit type will be determined after the service request handling thread exits. When the exit type is a hot upgrade type, a new service request handling thread is started, to handle service requests in the message stack and re-register all live monitoring events of the virtual machine on a physical server after the new request handling thread is started. So that the virtual machine management service module may be hot upgraded without losing any message.

In a general configuration, a computing device may include one or more processors (CPU), an input/output interface (1/0), a network interface and a memory.

The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage may be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

It is appreciated that, embodiments of the disclosure may be provided as a method, a system, and/or a computer program product. Therefore, the embodiments may be implemented in a form of hardware, software or a combination thereof. And, the embodiments may be in a form of a computer program product implemented on a computer readable storage medium containing computer readable program codes (including but not limited to a disk, a CD-ROM, an optical storage, and the like).

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

1. A method for hot upgrading a virtual machine management service module, comprising:
creating a request receiving thread and a request handling thread by a virtual machine management service module process, wherein the request receiving thread continuously receives a service request during the hot upgrading;
creating a handling thread management unit; and
managing, by the handling thread management unit, exit and new start of the request handling thread during the hot upgrading.

2. The method according to claim 1, wherein
the request receiving thread performs parsing and encoding on the service request, and sends the encoded service request to a message stack, and
the request handling thread extracts the encoded service request from the message stack and handles the service request.

3. The method according to claim 2, wherein the request receiving thread further
parses whether the service request is a normal request;
in response to the service request being not a normal request, reports an error;
in response to the service request being a normal request, encodes the service request; and
sends the encoded service request to the message stack.

4. The method according to claim 2, wherein the request handling thread further
extracts the encoded service request from the message stack;
decodes the encoded service request;
parses the decoded service request;
queries whether there is a method corresponding to the service request; and
in response to the method existing, handles the service request.

5. The method according to claim 1, wherein managing, by the handling thread management unit, exit and new start of the request handling thread during the hot upgrading comprises:
receiving a hot upgrade notification;
triggering, based on the hot upgrade notification, the request handling thread of a service processing process to exit;
determining an exit type of the request handling thread after it exits; and
in response to the exit type being a hot upgrade exit type, starting a new request handling thread.

6. The method according to claim 5, wherein determining an exit type of the request handling thread after it exits, upon the exit type being a hot upgrade exit type, starting a new request handling thread further comprises:
after the new request handling thread is started, extracting the parsed service request from the message stack by the new request handling thread.

7. The method according to claim 5, wherein triggering, based on the hot upgrade notification, the request handling thread of a service processing process to exit further comprises:
waiting for the request handling thread to check whether the service request is being handled currently; and
in response to the service request being handled currently, waiting to exit until the handling is completed.

8. The method according to claim 5, further comprising:
re-registering all live monitoring events after the new request handling thread is started.

9. The method according to claim 1, further comprising:
setting an import type of a main logic processing module related to the virtual machine management service module as a request handling thread import type.

10. The method according to claim 1, wherein the virtual machine management service module comprises at least one of:
a hypertext transfer protocol service processing process; and
a standard generalized markup language-based remote process call protocol service processing process.

11-20. (canceled)

21. A non-transitory computer readable medium that stores a set of instructions that is executable by at least one processor of an electronic apparatus to cause the electronic apparatus to perform a method for hot upgrading a virtual machine management service module, the method comprising:
creating a request receiving thread and a request handling thread by a virtual machine management service module process, wherein the request receiving thread receives a service request during the hot upgrading;
creating a handling thread management unit; and
managing, by the handling thread management unit, exit and new start of the request handling thread during the hot upgrading.

22. An apparatus for hot upgrading a virtual machine management service module, comprising:
one or more memory devices that store a set of instructions; and
one or more hardware processors configured to execute the set of instructions to cause the apparatus to:
create a request receiving thread and a request handling thread by a virtual machine management service module process, wherein the request receiving thread receives a service request during the hot upgrading;
create a handling thread management unit; and
manage, by the handling thread management unit, exit and new start of the request handling thread during the hot upgrading.

23. The apparatus of claim 22, wherein the request receiving thread performs parsing and encoding on the service request, and sends the encoded service request to a message stack, and
the request handling thread extracts the encoded service request from the message stack and handles the service request.

24. The apparatus according to claim 23, wherein the request receiving thread further
parses whether the service request is a normal request;
in response to the service request being not a normal request, reports an error;
in response to the service request being a normal request, encodes the service request; and
sends the encoded service request to the message stack.

25. The apparatus according to claim 23, wherein the request handling thread further
extracts the encoded service request from the message stack;
decodes the encoded service request;
parses the decoded service request;
queries whether there is a method corresponding to the service request; and
in response to the method existing, handles the service request.

26. The apparatus according to claim 22, wherein the one or more hardware processors are configured to execute the set of instructions to further cause the apparatus to:
receive a hot upgrade notification;
trigger, based on the hot upgrade notification, the request handling thread of a service processing process to exit;
determine an exit type of the request handling thread after it exits; and
in response to the exit type being a hot upgrade exit type, start a new request handling thread.

27. The apparatus according to claim 26, wherein the one or more hardware processors are configured to execute the set of instructions to further cause the apparatus to:
after the new request handling thread is started, extract the parsed service request from the message stack by the new request handling thread.

28. The apparatus according to claim 26, wherein the one or more hardware processors are configured to execute the set of instructions to further cause the apparatus to:
wait for the request handling thread to check whether the service request is being handled currently; and
in response to the service request being handled currently, wait to exit until the handling is completed.

29. The apparatus according to claim 26, wherein the one or more hardware processors are configured to execute the set of instructions to further cause the apparatus to:
re-register live monitoring events after the new request handling thread is started.

30. The apparatus according to claim 22, wherein the one or more hardware processors configured are configured to execute the set of instructions to further cause the apparatus to:
set an import type of a main logic processing module related to the virtual machine management service module as a request handling thread import type.
